(19) United States
(12) Patent Application Publication
(10) Pub. No.: US 2026/0108410 A1
(43) Pub. Date: Apr. 23, 2026

(54) Adjustable Headrest

(71) Applicants: Brian Scott Bowen, Greenwood Village, CO (US); Hsiang-Feng Chen Carroll, Greenwood Village, CO (US)

(72) Inventors: Brian Scott Bowen, Greenwood Village, CO (US); Hsiang-Feng Chen Carroll, Greenwood Village, CO (US)

(21) Appl. No.: 19/361,970

(22) Filed: Oct. 17, 2025

Related U.S. Application Data
(63) Continuation-in-part of application No. 18/923,557, filed on Oct. 22, 2024, now Pat. No. 12,465,539.

(51) Int. Cl. A61G 13/12; A61G 13/00; F16M 11/14; F16M 11/24; F16M 13/02

(52) U.S. Cl. CPC A61G 13/121; A61G 13/009; F16M 11/14; F16M 11/24; F16M 13/02

(57) ABSTRACT

Disclosed herein is a method of using an adjustable headrest for performing manual therapy on an individual. In some embodiments, the method comprises: configuring the adjustable headrest in a first configuration, performing manual therapy on the individual in the first configuration, reconfiguring the headrest in a second configuration, and performing manual therapy on the individual in the second configuration. In other embodiments, the method comprises performing manual therapy on the individual while moving a faceplate of the adjustable headrest relative to a base of the adjustable headrest. Manual therapy includes, but is not limited to, massage therapy, physical therapy, physiotherapy, acupuncture, and chiropractic treatment.

### CROSS-REFERENCE TO RELATED APPLICATIONS

This is a continuation-in-part of application Ser. No. 18/923,557, filed 22 Oct. 2024, and entitled ADJUSTABLE HEADREST which is hereby incorporated herein by reference for all purposes.

### TECHNICAL FIELD

The present invention is directed to apparatus and methods for supporting an individual. More particularly, the present invention is directed to apparatus and methods for supporting an individual's head.

### BACKGROUND

Many personal treatments and manual therapy treatments, including but not limited to massage therapy, physical therapy, physiotherapy, acupuncture, and chiropractic treatments, require an individual lie upon a treatment table. When lying upon the treatment table, the individual's head must be supported.

Many treatment tables lack suitable headrests for an individual's head. As such, various headrests that are mountable to a treatment table exist. However, many of the existing headrests suffer various limitations. Such limitations include: an inability to support an individual's head in multiple alternate positions, an inability to support an individual's head during movement of their head, and being limited in the degrees of movement of the headrest, among others.

Given the limitations in existing headrests, there is a general desire for an improved adjustable headrest. Additionally, there is a general desire for an adjustable headrest capable of supporting an individual's head in multiple alternate positions, for example prone, supine, and seated positions. Furthermore, there is a need when performing manual therapies for an adjustable headrest capable of supporting an individual's head during treatments involving movement of the individual's head.

The foregoing examples of the related art and limitations related thereto are intended to be illustrative and not exclusive. Other limitations of the related art will become apparent to those of skill in the art upon a reading of the specification and a study of the drawings.

### SUMMARY

Further aspects and example embodiments are illustrated in the accompanying drawings and/or described in the following description.

One embodiment of the present invention provides a method of using an adjustable headrest for performing manual therapy treatment on an individual, the headrest comprising a base mountable to a treatment table, a slider rail mounted to the base, a support arm configured to slide along the slider rail, a lockable ball joint mounted to the support arm, and a faceplate mounted to the ball joint, the method comprising: configuring the headrest in a first configuration by sliding the support arm over the slider rail and extending from a first side of the slider rail; supporting the individual's head with the headrest configured in the first configuration; performing manual therapy on the individual with the headrest configured in the first configuration; detaching the support arm from the slider rail by sliding the support arm off of the slider rail; configuring the headrest in a second configuration by sliding the support arm over the slider rail and extending from a second side of the slider rail opposing the first side of the slider rail; supporting the individual's head with the headrest configured in the second configuration; and performing manual therapy on the individual with the headrest configured in the second configuration.

One embodiment of the present invention provides a method of using an adjustable headrest for performing manual therapy on an individual, the headrest comprising a base mountable to a treatment table, a slider rail mounted to the base, a support arm configured to slide along the slider rail, a lockable ball joint mounted to the support arm, and a faceplate mounted to the ball joint, and the method comprising: supporting the individual's head with the headrest; applying a first amount of resistance to movement of the ball joint; performing manual therapy on the individual while the ball joint is under the first amount of resistance to movement, wherein the first amount of resistance is sufficient to restrain movement of the faceplate relative to the base while the individual is receiving manual therapy; applying a second amount of resistance to movement of the ball joint less than the amount level of resistance; and performing manual therapy on the individual while moving the faceplate relative to the base and the ball joint is under the second amount of resistance to movement.

One embodiment of the present invention provides an adjustable headrest comprising: a base mountable to a treatment table; a slider rail mounted to the base; a support arm configured to slide along the slider rail; a lockable ball joint mounted to the support arm; a support member mounted to the ball joint; and a faceplate mounted to the support member, wherein the support arm is configured to slide to a first position along the slider rail and a second position along the slider rail, wherein the faceplate is configured to support an individual's head in a prone position when the support arm is at the first position, wherein the faceplate is configured to support the individual's head in a supine position when the support arm is at the second position, wherein the slider rail has a first side and an opposing second side, wherein the support arm extends from the first side of the slider rail when the support arm is at the first position, and the support arm extends from the second side of the slider rail when the support arm is at the second position, wherein the base comprises a strut having two opposing ends and two mounting members attached to the opposing ends of the strut, wherein the slider rail extends from the strut between the opposing ends of the strut, wherein the support arm extends over the two mounting members when the slider rail is at the first position, and wherein the support arm extends from the slider rail opposing the two mounting members when the slider rail is at the second position.

One embodiment of the present invention provides a method of using an adjustable headrest for performing a manual therapy on an individual, the headrest comprising a base mountable to a treatment table, a slider rail mounted to the base, a support arm configured to slide along the slider rail, a lockable ball joint mounted to the support arm, and a faceplate mounted to the ball joint, the method comprising: configuring the headrest in a first configuration by sliding the support arm over the slider rail and extending from a first side of the slider rail; supporting the individual's head with the headrest configured in the first configuration; performing the manual therapy on the individual with the headrest configured in the first configuration; detaching the support arm from the slider rail by sliding the support arm off of the slider rail; configuring the headrest in a second configuration by sliding the support arm over the slider rail and extending from a second side of the slider rail opposing the first side of the slider rail; supporting the individual's head with the headrest configured in the second configuration; and performing the manual therapy on the individual with the headrest configured in the second configuration.

In some embodiments, performing the manual therapy on the individual with the headrest configured in the first configuration comprises performing the manual therapy on the individual in a first one of a prone position, a supine position, and a seated position; and performing the manual therapy on the individual with the headrest configured in the second configuration comprises performing the manual therapy on the individual in a second one of the prone position, the supine position, and the seated position.

In some embodiments, the base comprises a strut having two opposing ends and two mounting members attached to the opposing ends of the strut; sliding the support arm over the slider rail and extending from the first side of the slider rail comprises sliding the support arm over the slider rail and extending over the two mounting members; and sliding the support arm over the slider rail and extending from the second side of the slider rail comprises sliding the support arm over the slider rail and opposing the two mounting members.

In some embodiments, configuring the headrest in the first configuration comprises mounting the base to the treatment table with the slider rail extending upward from the base and the treatment table; and configuring the headrest in the second configuration comprises: detaching the base from the treatment table; and mounting the base to the treatment table with the slider rail extending downwards from the base and the treatment table.

In some embodiments, sliding the support arm over the slider rail and extending from the first side of the slider rail comprises sliding the support arm over the slider rail while the slider rail extends upwards from the base; and sliding the support arm over the slider rail and extending from the second side of the slider rail comprises sliding the support arm over the slider rail while the slider rail extends downwards from the base.

In some embodiments, performing the manual therapy on the individual with the headrest configured in the first configuration comprises performing the manual therapy on the individual in a supine position; and performing the manual therapy on the individual with the headrest configured in the second configuration comprises performing the manual therapy on the individual in a prone position.

In some embodiments, the base comprises a strut having two opposing ends and two mounting members attached to the opposing ends of the strut; the method further comprises mounting the base to the treatment table with the slider rail extending upwards from the base and the treatment table; configuring the headrest in the first configuration comprises sliding the support arm over the slider rail and extending towards the mounting members and over the treatment table; and configuring the headrest in the second configuration comprises sliding the support arm over the slider rail and extending opposed to the mounting members and opposed to the treatment table.

In some embodiments, performing the manual therapy on the individual with the headrest configured in the first configuration comprises performing the manual therapy on the individual in a supine position; and performing the manual therapy on the individual with the headrest configured in the second configuration comprises performing the manual therapy on the individual in a seated position.

In some embodiments, the base comprises a strut having two opposing ends and two mounting members attached to the opposing ends of the strut; configuring the headrest in the first configuration comprises: mounting the base to the treatment table with the slider rail extending upwards from the base and the treatment table; and sliding the support arm over the slider rail and extending towards the mounting members and over the treatment table; and configuring the headrest in the second configuration comprises: detaching the base from the treatment table; resting the base and two mounting members upon the treatment table; and sliding the support arm over the slider rail and extending towards the mounting members.

In some embodiments, performing the manual therapy on the individual with the headrest configured in the first configuration comprises performing the manual therapy on the individual in a supine position; and performing the manual therapy on the individual with the headrest configured in the second configuration comprises performing the manual therapy on the individual in a seated position.

In some embodiments, the support arm further comprises a thumb screw: configuring the headrest in the first configuration further comprises locking the thumb screw with the support arm extending from the first side of the slider rail; detaching the support arm from the slider rail further comprises releasing the thumb screw with the support arm extending from the first side of the slider rail; and configuring the headrest in the second configuration further comprises locking the thumb screw with the support arm extending from the second side of the slider rail.

In some embodiments, the method further comprises mounting the base to the treatment table by sliding the two mounting members into two respective receiving apertures of the treatment table.

In some embodiments, configuring the headrest in the first configuration further comprises locking the lockable ball joint while the support arm extends from the first side of the slider rail; detaching the support arm from the slider rail further comprises unlocking the lockable ball joint while the support arm extends from the first side of the slider rail; and configuring the headrest in the second configuration further comprises locking the lockable ball joint while the support arm extends from the second side of the slider rail.

In some embodiments, locking the lockable ball joint comprises tightening a thumbscrew of the lockable ball joint to restrain movement of the lockable ball joint while performing the manual therapy on the individual.

One embodiment of the present invention provides a method of using an adjustable headrest for performing a static manual therapy and a dynamic manual therapy on an individual, the headrest comprising a base mountable to a treatment table, a slider rail mounted to the base, a support arm configured to slide along the slider rail, a lockable ball joint mounted to the support arm, and a faceplate mounted to the ball joint, the method comprising: supporting the individual's head with the headrest; applying a first amount of resistance to movement of the ball joint; performing the static manual therapy on the individual while the ball joint is under the first amount of resistance to movement, wherein the first amount of resistance is sufficient to restrain movement of the faceplate relative to the base while the individual is receiving the static manual therapy; applying a second amount of resistance to movement of the ball joint less than the first amount of resistance; and performing the dynamic manual therapy on the individual while moving the faceplate relative to the base and the ball joint is under the second amount of resistance to movement.

In some embodiments, the ball joint comprises a thumb screw; applying the first amount of resistance to movement of the ball joint comprises tightening the thumb screw by a first number of turns; and applying the second amount of resistance to movement of the ball joint comprises tightening the thumb screw by a second number of turns less than the first number of turns. In some embodiments, moving the faceplate relative to the base comprises one or more of: pitching the ball joint, yawing the ball joint, and rolling the ball joint.

In some embodiments, moving the faceplate relative to the base comprises one or more of: rotating the ball joint, rolling the ball joint, and spinning the ball joint.

In some embodiments, performing the static manual therapy on the individual while the ball joint is under the first amount of resistance to movement comprises performing the static manual therapy on one or more of the individual's neck and shoulders, and performing the dynamic manual therapy on the individual while moving the ball joint under the second amount of resistance to movement comprises performing the dynamic manual therapy on one or more of the individual's neck and shoulders while moving the faceplate relative to the base.

In some embodiments, performing the dynamic manual therapy on one or more of the individual's neck and shoulders while moving the faceplate relative to the base comprises applying pressure to a location on the individual's neck or shoulders, and moving the faceplate relative to the base while holding steady the applied pressure to thereby slide the applied pressure along the individual's neck or shoulders to a second location on the individual's neck or shoulders.

In addition to the exemplary aspects and embodiments described above, further aspects and embodiments will become apparent by reference to the drawings and by study of the following detailed descriptions.

### BRIEF DESCRIPTION OF THE DRAWINGS

The accompanying drawings illustrate non-limiting example embodiments of the invention.

FIG. 1A is a front perspective view of an adjustable headrest in a supine configuration, according to an example embodiment of the present invention.

FIG. 1B is an exploded perspective view of the adjustable headrest of FIG. 1A.

FIG. 1C is a bottom perspective view of the adjustable headrest of FIG. 1A.

FIG. 1D is a left-side elevation view of the adjustable headrest of FIG. 1A.

FIG. 1E is a right-side elevation view of the adjustable headrest of FIG. 1A.

FIG. 1F is a front-side elevation view of the adjustable headrest of FIG. 1A.

FIG. 2A is a side perspective view of the adjustable headrest of FIG. 1A in a prone configuration, according to example embodiments of the present invention.

FIG. 2B is a right-side elevation view of the adjustable headrest of FIG. 2A.

FIG. 2C is a left-side elevation view of the adjustable headrest of FIG. 2A.

FIGS. 3A and 3B are perspective views of a base and slider rail of an adjustable headrest mounted to a treatment table, according to example embodiments of the present invention.

FIG. 4A is a side perspective view of the adjustable headrest of FIG. 1A sitting upon a treatment table in a seated configuration, according to example embodiments of the present invention.

FIG. 4B is a perspective views of the adjustable headrest of FIG. 1A mounted to a treatment table in a seated configuration, according to an example embodiment of the present invention.

FIGS. 5A and 5B are perspective views of the adjustable headrest of FIG. 1A mounted to a treatment table in a prone configuration, and moved between FIGS. 5A and 5B while an individual is resting upon the adjustable headrest, according to an example embodiment of the present invention.

FIGS. 6A and 6B are perspective views of the adjustable headrest of FIG. 1A mounted to a treatment table in a seated configuration, and moved between FIGS. 6A and 6B while an individual is resting upon the adjustable headrest, according to an example embodiment of the present invention.

FIGS. 7A and 7B are perspective views of the adjustable headrest of FIG. 1A mounted to a treatment table in a flat supine configuration, and moved between FIGS. 7A and 7B while an individual is resting upon the adjustable headrest, according to an example embodiment of the present invention.

FIGS. 8A and 8B are perspective views of the adjustable headrest of FIG. 1A mounted to a treatment table in a raised supine configuration, and moved between FIGS. 8A and 8B while an individual is resting upon the adjustable headrest, according to an example embodiment of the present invention.

FIG. 9A is a schematic diagram of a method of using an adjustable headrest for performing a manual therapy on an individual, according to an example embodiment of the present invention.

FIG. 9B is a schematic diagram of a method of using an adjustable headrest for performing a manual therapy on an individual, according to another example embodiment of the present invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

The same reference numerals may be used across multiple figures to indicate the same elements in the figures. Unless indicated otherwise, the same reference numeral indicates the same element across figures.

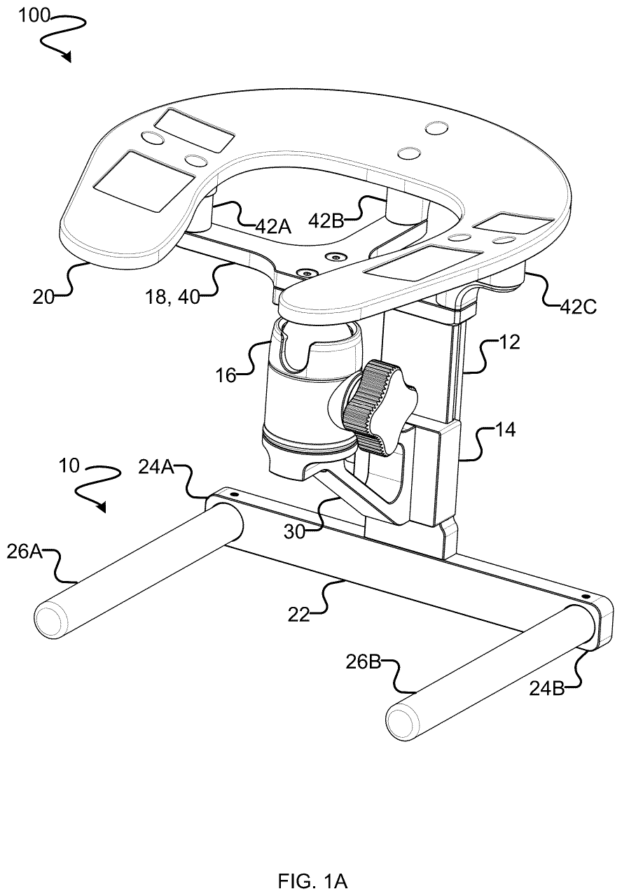

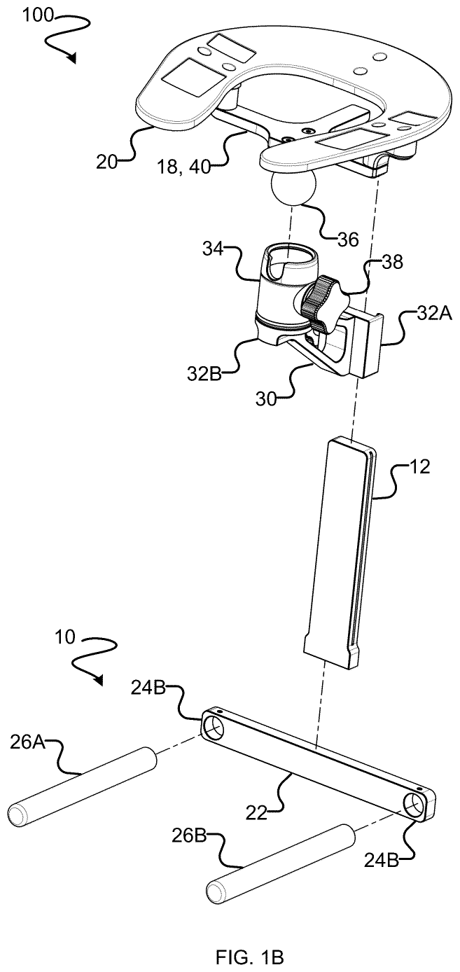

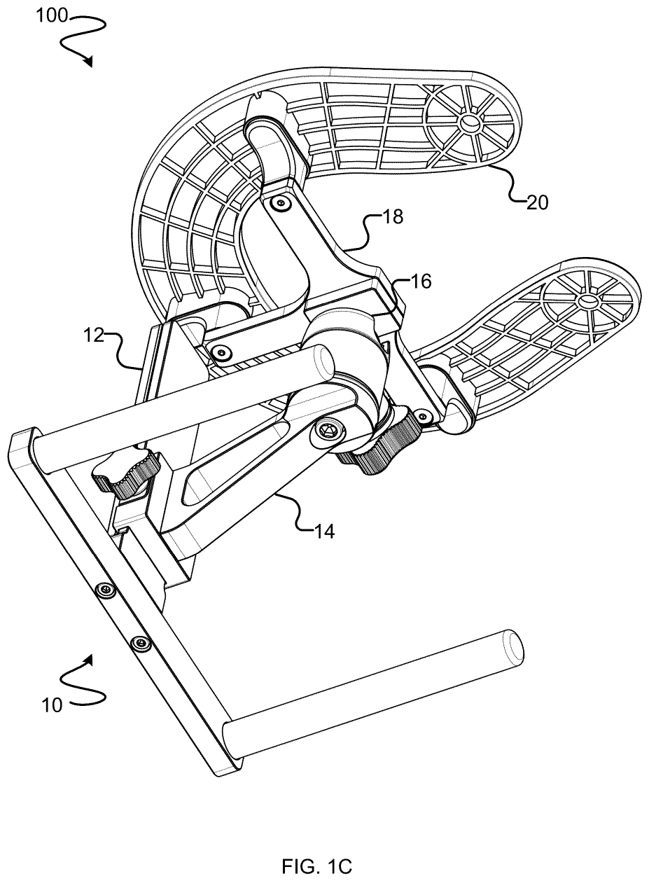

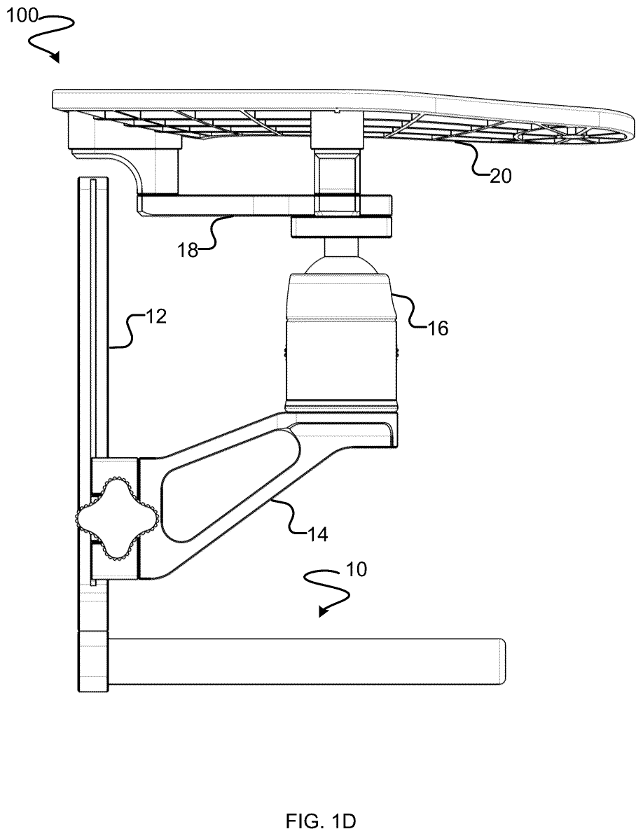

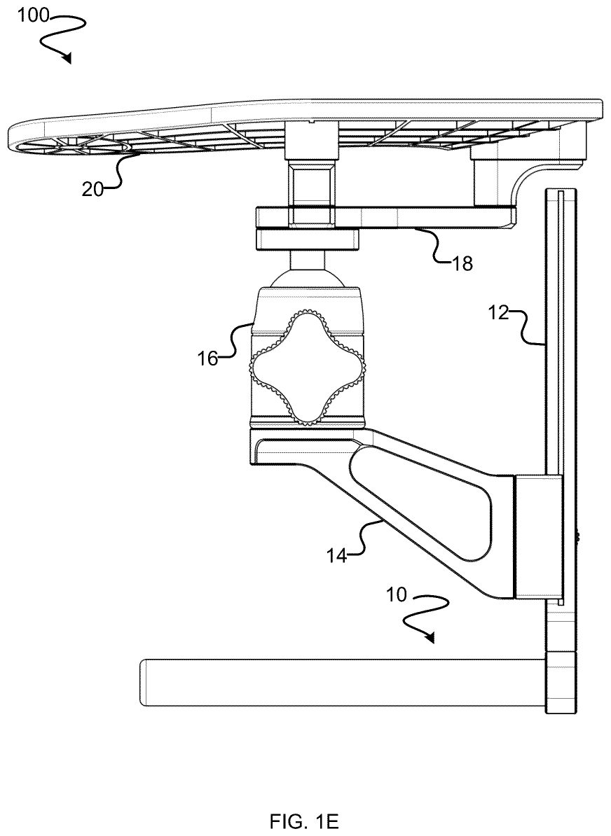

FIG. 1A is a front perspective view of adjustable headrest 100 according to an example embodiment of the present invention. Headrest 100 comprises base 10, wherein base 10 is mountable to a treatment table. Headrest 100 further comprises slider rail 12 mounted to base 10, and support arm 14 configured to slide along slider rail 12. Lockable ball joint 16 is mounted to support arm 14, and support member 18 is mounted to ball joint 16. Support member 18 supports faceplate 20, and faceplate 20 is configured to support a cushion (not shown).

In some embodiments, ball joint 16 may allow a variable amount of resistance to movement of the ball joint to be applied. The variable amount of resistance may include a first amount of resistance sufficient to lock the ball joint against movement while an individual resting upon the headrest is receiving manual therapy. The variable amount of resistance may further include a second amount of resistance less than the first amount of resistance, wherein the second amount of resistance permits movement of the ball joint while the individual resting upon the headrest is receiving manual therapy.

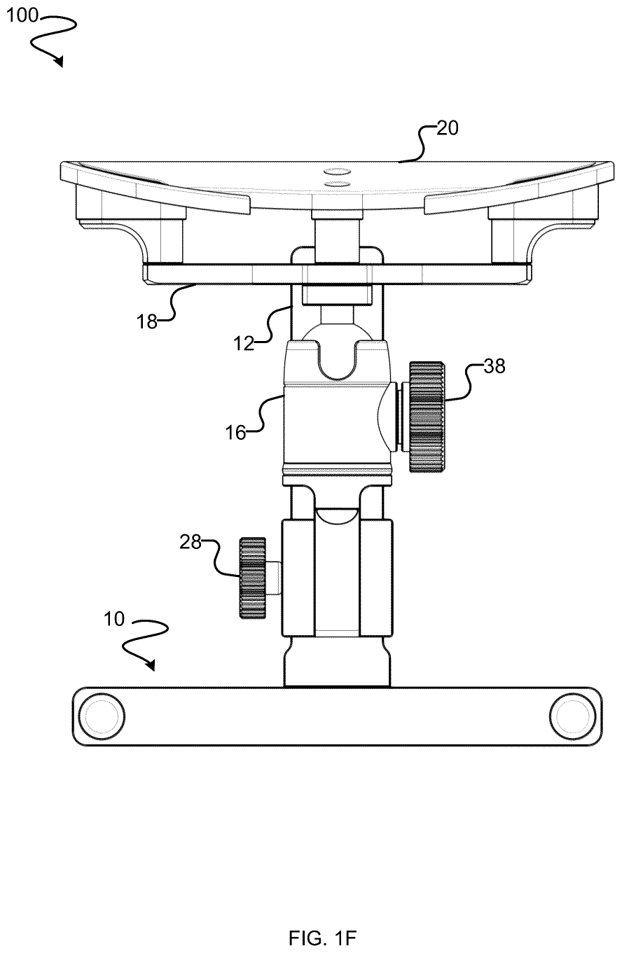

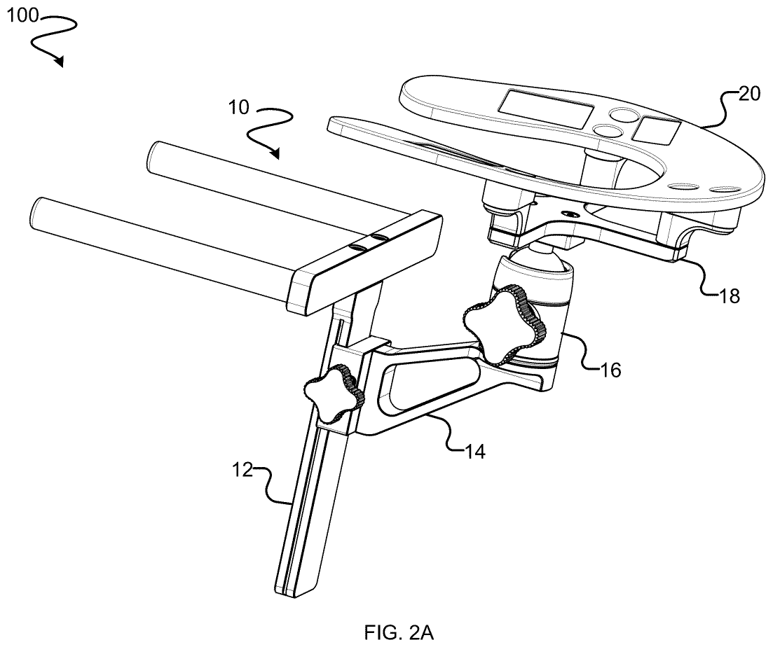

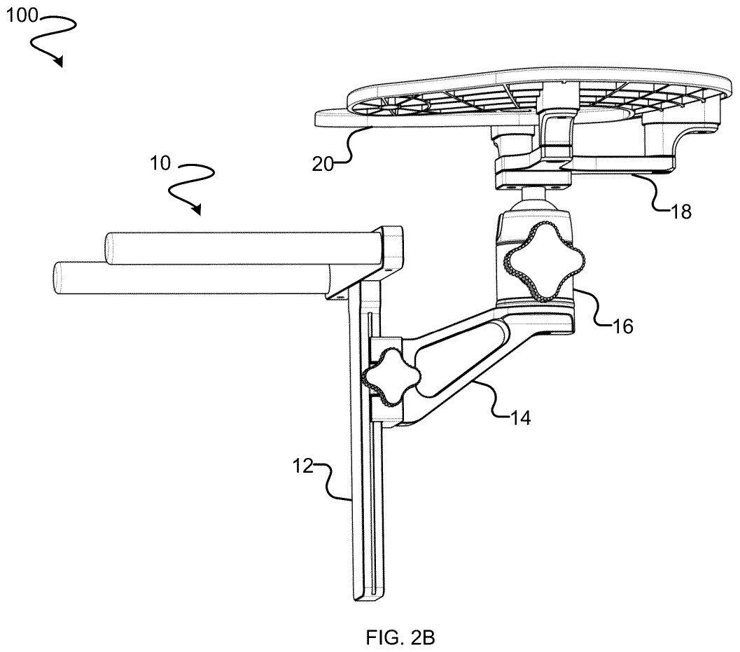

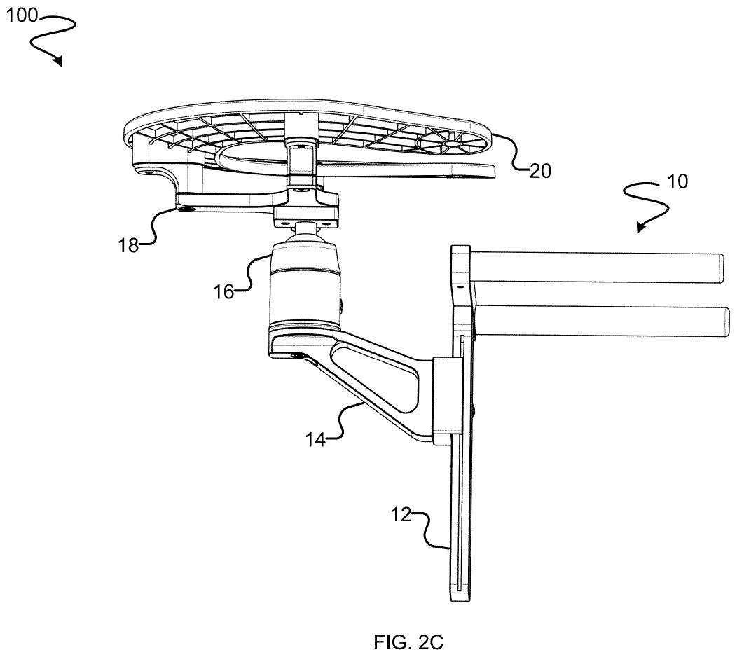

FIGS. 1B to 1F are further views of adjustable headrest 100, depicting headrest 100 in a first configuration. FIGS. 2A to 2C are further views of adjustable headrest 100, depicting headrest 100 in a second configuration. In some embodiments, the first configuration may be used to support an individual in a supine posture, and the second configuring may be used to support an individual in a prone position.

Faceplate 20 of headrest 100 may be raised and lowered relative to base 10 by sliding support arm 14 along slider rail 12. Faceplate 20 may be rotated and/or spun relative to base 10 by rotating and/or spinning ball joint 16. Where headrest 100 is mounted to a treatment table, faceplate 20 may be raised, lowered, rotated, and/or spun relative to the treatment table.

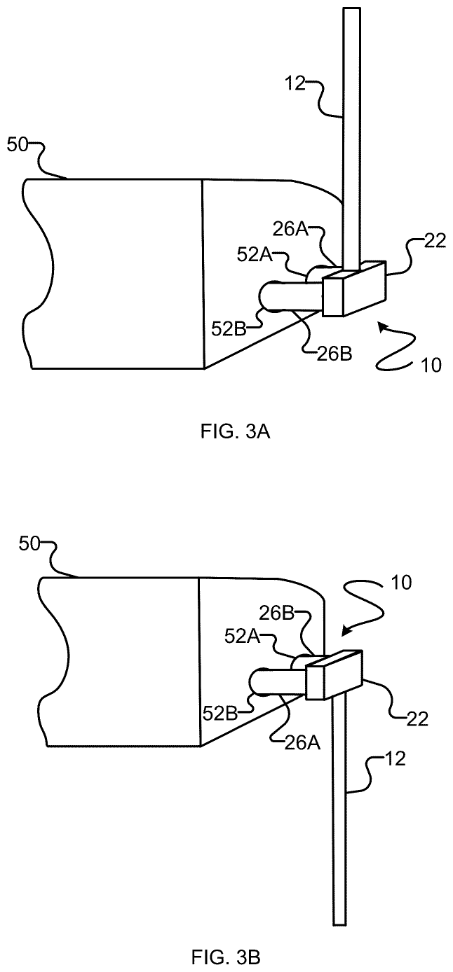

In some embodiments, headrest 100 may be configured and mounted to a treatment table in one of two configurations: a supine configuration as depicted in FIGS. 1A to 1F and 3A, and a prone configuration as depicted in FIGS. 2A to 2C and 3B. In the supine configuration of headrest 100, as depicted in FIG. 3A, base 10 is mounted to treatment table 50 with slider rail 12 extending upwards from treatment table 50. In the prone configuration of headrest 100, as depicted in FIG. 3B, base 10 is mounted to treatment table 50 with slider rail 12 extending downwards from treatment table 50. Mounting base 10 to treatment table 50 in the supine configuration may allow support arm 14 to be raised higher relative to base 10, and thereby higher relative to treatment table 50, than when base 10 is mounted to treatment table 50 in the prone configuration. Mounting base 10 to treatment table 50 in the prone configuration may allow support arm 14 to be lowered lower relative to base 10, and thereby lower relative to treatment table 50, than when base 10 is mounted to treatment table 50 in the supine configuration.

In one or both of the supine configuration and the prone configuration of headrest 100, headrest 100 may facilitate movement of an individual's head during manual therapy. Non-limiting examples of manual therapies include massage therapy, physical therapy, physiotherapy, acupuncture, and chiropractic treatment, and the like.

For example, by one or more of rotating, spinning, and swinging faceplate 20 relative to base 10 during a treatment, an individual's head resting upon faceplate 20 may be rotated, spun, and/or swung during the treatment. Such movement of an individual's head during a treatment may enable dynamic treatment of the individual. For example, a treatment professional may apply pressure to a location on the individual's head, neck, or shoulders, and instead of a conventional technique of moving the application of pressure, the professional may instead move the individual's head relative to the application of pressure. The movement of the faceplate may be effected manually by the treatment professional or passively by the individual's own head movement, depending on the therapeutic goal and the level of resistance applied to the ball joint. In another example, the treatment professional may move the individual's head to facilitate stretching of the individual's neck and/or shoulders during a treatment.

In some embodiments of headrest 100, base 10 comprises strut 22 having first end 24A and opposing second end 24B (collectively, opposing ends 24). Base 10 further comprises mounting member 26A and 26B (collectively, mounting member 26) mounted to opposing ends 24 of strut 22. Slider rail 12 extends from strut 22 between opposing ends 24 of strut 22.

Mounting members 26 are configured to be mounted to treatment table 50. FIGS. 3A and 3B are schematic diagrams depicting base 10 and slider rail 12 of headrest 100 mounted to treatment table 50 in a supine configuration (FIG. 3A), and a prone configuration (FIG. 3B). FIGS. 3A and 3B depict an embodiment of mounting members 26, wherein each of mounting members 26 comprise a tubular projection.

Tubular mounting members 26 are configured to be received by treatment table 50, for example first aperture 52A and second aperture 52B (collectively, apertures 52) of treatment table 50. In such embodiments, the distance between mounting members 26 equals a distance between apertures 52. Apertures 52 may comprise circular apertures.

In some embodiments, adjustable headrest 100 may be readily reconfigurable between the first configuration and the second configuration. For example, where adjustable headrest 100 comprises tubular projections 26, each of tubular projections 26 are configured to be received by either one of two circular apertures 52 of treatment table 50. Adjustable headrest 100 may be configured in the first configuration by inserting first tubular projection 26A into first circular aperture 52A, and second tubular projection 26B into second circular aperture 52B. Adjustable headrest 100 may then be reconfigured into the second configuration by removing tubular projections 26 from circular apertures 52, and inserting second tubular projection 26B into first circular aperture 52A and first tubular projection 26A into second circular aperture 52B. As such, adjustable headrest 100 may be readily reconfigurable between the first configuration and the second configuration.

In some embodiments, mounting members 26 may further comprise one or more features for securing mounting members 26 to the treatment table. For example, mounting members 26 may comprise one or more clamps (not shown), wherein the clamps secure mounting members 26 to the treatment table, once headrest 100 is mounted to the treatment table.

Support arm 14 is configured to slide along slider rail 12 while being restrained against rotation around slider rail 12. In order to restrain support arm 14 from rotating about slider rail 12, slider rail 12 may have at least one bearing surface which a corresponding surface of support arm 14 slides along. The bearing surfaces may restrain rotation of support arm 14 about slider rail 12 as support arm 14 slides along slider rail 12.

Slider rail 12 may comprise one or more longitudinal grooves, and support arm 14 may have a corresponding number of projections configured to slide through the longitudinal grooves of slider rail 12 as support arm 14 slides along slider rail 12. The grooves of slider rail 12 and corresponding projections of support arm 14 may hold support arm 14 to slider rail 12, while permitting support arm 14 to slide along slider rail 12. Furthermore, the grooves and projections may further restrain rotation of support arm 14 about slider rail 12.

One or both of slider rail 12 and support arm 14 may further comprise features for arresting the sliding of support arm 14 along slider rail 12. For example, support arm 14 may comprise clamp 28, wherein clamp 28 selectively locks support arm 14 to slider rail 12. In some embodiments, clamp 28 comprises a thumb screw configured to screw through support arm 14 and press against the slider rail 12, thereby arresting the sliding of support arm 14 along slider rail 12.

Support arm 14 may comprise spar 30 having first end 32A and second opposing end 32B. First end 32A of spar 30 may be configured to slide along slider rail 12, and ball joint 16 may be mounted to second end 32B of spar 30. In some embodiments, spar 30 comprises a projection configured to slide along a longitudinal groove of slider rail 12.

Ball joint 16 may comprise socket 34 and ball and stud 36 sitting in socket 34. In some embodiments, socket 34 of ball joint 16 is mounted to support arm 14. For example, where support arm 14 comprises spar 30, socket 34 may be mounted to second end 32B of spar 30. Faceplate 20 may be mounted to the stud of ball and stud 36.

To selectively lock ball joint 16, ball joint 16 may further comprise thumb screw 38 configured to screw through socket 34 and press against the ball of ball and stud 36, thereby locking the ball of ball and stud 36 against rotating within socket 34. Thumb screw 38 may comprise a threaded bar, and stud 36 may form a threaded aperture configured to receive the threaded bar of thumb screw 38. Thumb screw 38 may further comprise a knob to facilitate screwing the threaded bar through the threaded aperture and bearing down of the threaded bar against the ball of ball and stud 36.

In some embodiments, support member 18 comprises central body 40 mounted to ball joint 16 and three arms 42A, 42B and 42C (collectively, arms 42) extending from central body 40. Each of arms 42 may comprise a flexibly resilient riser, wherein the risers support faceplate 20. The risers may deflect and/or compress to facilitate passive adjustment of faceplate 20 to an individual's head. Passive adjustment of faceplate 20 means lowering of one or more of the risers to shift weight from the lowered risers to the other risers, thereby redistributing the weight between the risers.

Faceplate 20 may comprise a U-shaped plate supported by arms 42. In some embodiments, U-shaped faceplate 20 is evenly supported by arms 42. Evenly supported may mean each of arms 42 supports a generally similar weight of faceplate 20, when faceplate 20 supports an individual's head. U-shaped faceplate 20 may support an individual's forehead and cheeks when the individual is in a prone position without supporting the individual's chin, thereby removing any pressure from the individual's chin.

In some embodiments, headrest 100 is configured to support an individual's head in both a prone position and a supine position. Support arm 14 may be configured to slide to a first position along slider rail 12 for supporting the individual's head in the prone position, and to a second position along slider rail 12 for supporting the individual's head in the supine position. In some embodiments, base 10 may be configured to be mounted to a treatment table in two configurations, a first configuration wherein slider rail 12 extends upward from base 10, and a second configuration wherein slider rail 12 extends downwards from base 10. In such embodiments, upwards is defined away from the ground, and downwards is defined as towards the ground.

Support arm 14 may be configured to slide along slider rail 12 when slider rail 12 extends either upwards from or downwards from base 10. In some embodiments, slider rail 12 may form two longitudinal grooves along opposing sides of slider rail 12, and support arm 14 may have two corresponding projections. As such, each of the projections of support arm 14 may slide through either of the grooves of slider rail 12. This allows support arm 14 to slide along slider rail 12 when base 10 is mounted in either a prone or a supine configuration, as otherwise described herein.

The first configuration of base 10 with slider rail 12 extending upwards may support the individual's head in the supine position, and the second configuration of base 10 with slider rail 12 extending downwards may support the individual's head in the prone position. The second configuration of base 10 may allow headrest 20 to be lowered lower relative to the treatment table than the first configuration of base 10. As such, the second configuration of base 10 may permit a wider range of heights for headrest 20 suitable for supporting the individual's head in the prone position relative to the treatment table. Similarly, the second configuration of base 10 may permit a wider range of heights for headrest 20 relative to the treatment table and therefore suitable for supporting the individual's head in the supine position. Accordingly, headrest 100 may support a wider range of headrest heights relative to the treatment table than if base 10 were mountable to the treatment table in only the first or the second configuration.

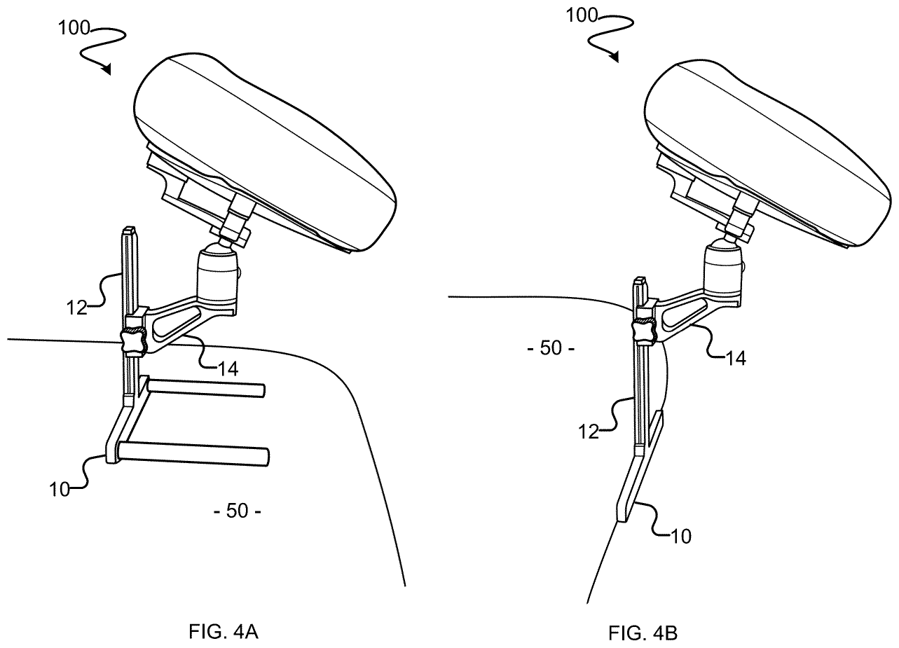

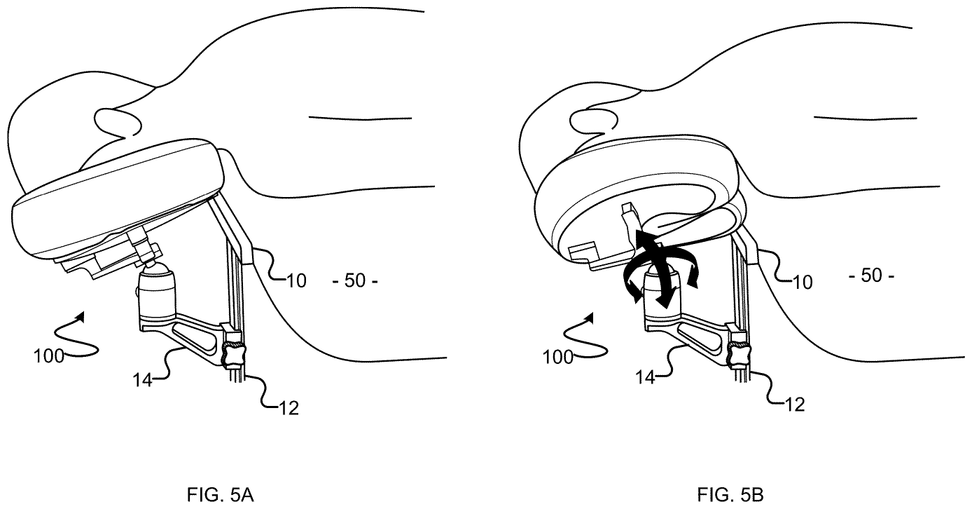

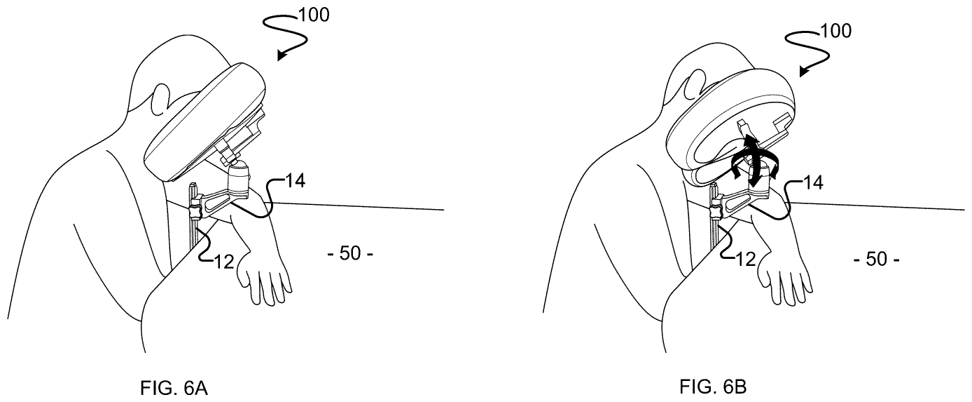

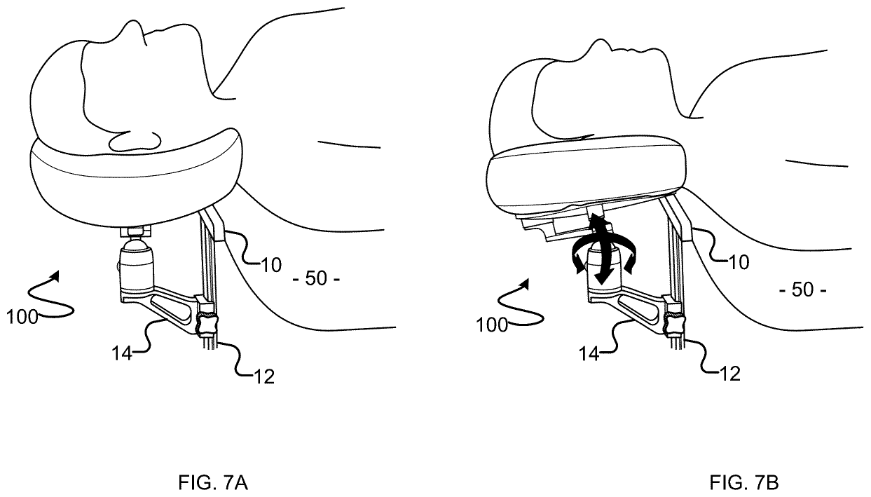

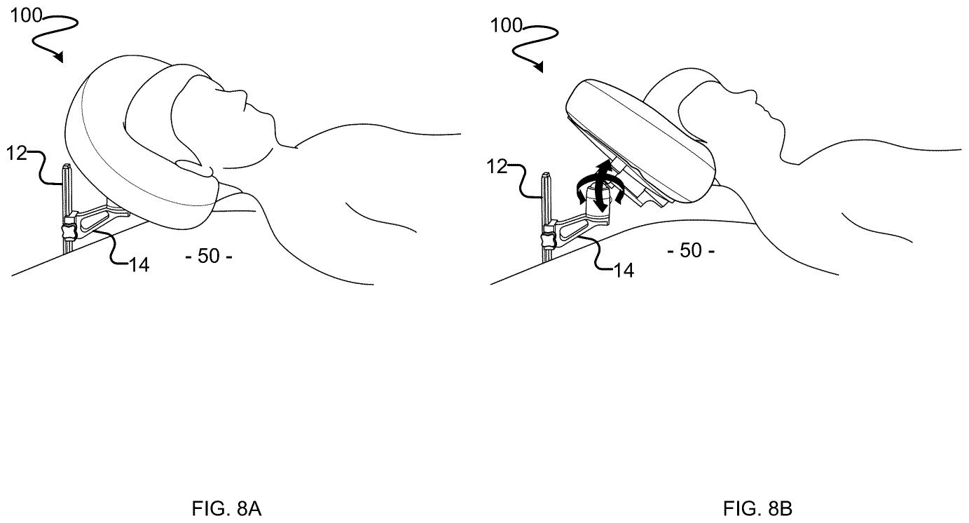

In some embodiments, adjustable headrest 100 may be configured in two or more of a plurality of configurations, for example two or more of:
a seated configuration mounted to a treatment table, as depicted in FIGS. 4B, 6A and 6B;
a prone configuration mounted to a treatment table, as depicted in FIGS. 5A and 5B;
a seated configuration resting upon a treatment table, as depicted in FIG. 4A;
a flat supine configuration mounted to a treatment table, as depicted in FIGS. 7A and 7B; and
a raised supine configuration mounted to a treatment table, as depicted in FIGS. 8A and 8B.

In some embodiments, the prone configuration and the flat supine configuration may both comprise adjustable headrest 100 mounted to the treatment table with slider rail 12 extending downwards from the treatment table, and support arm 14 extending from slider rail 12 opposed to mounting members 26. In such embodiments, the difference between the prone configuration and the flat supine configuration may be the position along slider rail 12 where support arm 14 is mounted, for example the prone configuration may have support arm 14 lower along slider rail 12 than in the flat supine configuration.

In some embodiments, the seated configuration mounted to the treatment table may comprise adjustable headrest 100 mounted to the treatment table with slider rail 12 extending upwards from the treatment table, and support arm 14 extending from either side of slider rail, as alternatively depicted in FIG. 4B and FIG. 6A.

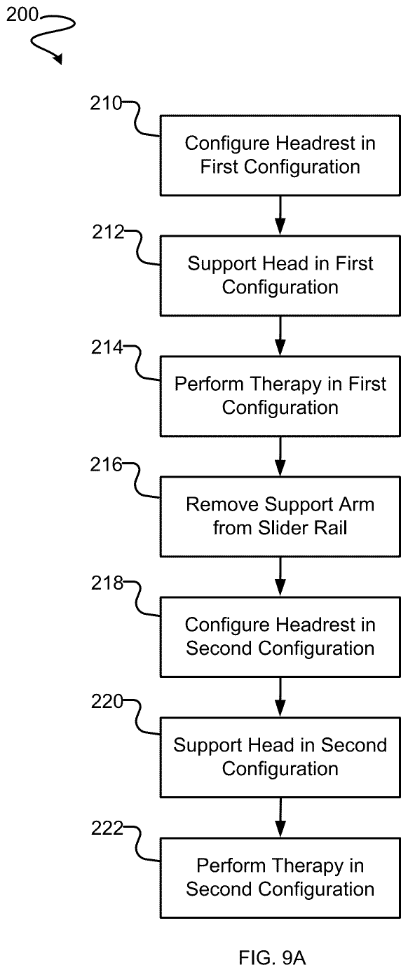

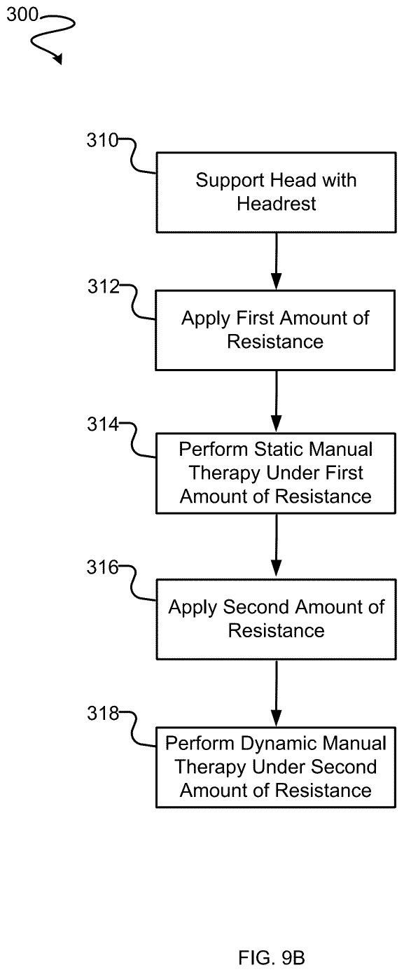

FIG. 9A is a schematic diagram of method 200 of using an adjustable headrest for performing a manual therapy on an individual, according to an example embodiment of the present invention. The headrest comprises a base mountable to a treatment table, a slider rail mounted to the base, a support arm configured to slide along the slider rail, a lockable ball joint mounted to the support arm, and a faceplate mounted to the ball joint.

Method 200 comprises:
step 210: configuring the headrest in a first configuration by sliding the support arm over the slider rail and extending from a first side of the slider rail;
step 212: supporting the individual's head with the headrest configured in the first configuration;
step 214: performing the manual therapy on the individual with the headrest configured in the first configuration;
step 216: detaching the support arm from the slider rail by sliding the support arm off of the slider rail;
step 218: configuring the headrest in a second configuration by reattaching the support arm to the slider rail by sliding the support arm over the slider rail and extending from a second side opposing the first side of the slider rail;
step 220: supporting the individual's head with the headrest configured in the second configuration; and
step 222: performing the manual therapy on the individual with the headrest configured in the second configuration.

In some embodiments, method 200 may comprise performing a manual therapy on an individual using adjustable headrest 100.

FIG. 9B is a schematic diagram of method 300 of using an adjustable headrest for performing a static manual therapy and a dynamic manual therapy on an individual, according to an example embodiment of the present invention. The headrest comprises a base mountable to a treatment table, a slider rail mounted to the base, a support arm configured to slide along the slider rail, a lockable ball joint mounted to the support arm, and a faceplate mounted to the ball joint.

Method 300 comprises:
step 310: supporting the individual's head with the headrest;
step 312: applying a first amount of resistance to movement of the ball joint;
step 314: performing the static manual therapy on the individual while the ball joint is under the first amount of resistance to movement, wherein the first amount of resistance is sufficient to restrain movement of the faceplate relative to the base while the individual is receiving the static manual therapy;
step 316: applying a second amount of resistance to movement of the ball joint less than the first amount of resistance;
step 318: performing the dynamic manual therapy on the individual while moving the faceplate relative to the base and the ball joint is under the second amount of resistance to movement.

In some embodiments, method 300 may comprise performing a static manual therapy and a dynamic manual therapy on an individual using adjustable headrest 100.

While a number of exemplary aspects and embodiments have been discussed above, those of skill in the art will recognize certain modifications, permutations, additions, and sub-combinations thereof. It is therefore intended that the following claims are interpreted to include all such modifications, permutations, additions, and sub-combinations as are consistent with the broadest interpretation of the specification as a whole.

### Example Embodiments

Some embodiments of the present invention may comprise performing a static manual therapy on an individual using an adjustable headrest. As used herein, a static manual therapy means a manual therapy performed on an individual resting their head upon a faceplate of the adjustable headrest, wherein the faceplate supports the individual's head, and the faceplate remains static relative to a base of the adjustable headrest during the static manual therapy. Remaining static may mean the faceplate of the adjustable headrest moving less than a threshold amount relative to the base of the adjustable headrest, for example a translational movement of less than 5 millimeter (mm), and/or a rotational movement of less than 0.5 degrees.

Some embodiments of the present invention may comprise performing a dynamic manual therapy on an individual using an adjustable headrest. As used herein, a dynamic manual therapy means a manual therapy performed on an individual resting their head upon a faceplate of the adjustable headrest, wherein the faceplate supports the individual's head, and the faceplate moves relative to a base of the adjustable headrest, thereby moving the individual's upper body, during the dynamic manual therapy. The individual's upper body may include one or more of the individual's head, one or both shoulders, neck, and upper back. Moving the upper body during the dynamic manual therapy may comprise a part of the manual therapy treatment in itself, or be combined with other manual therapy treatments such as massage therapy to together comprise a composite manual therapy treatment.

In some embodiments of the present invention, each of mounting members 26 and apertures 52 form in cross section a symmetrical shape. Examples of symmetrical shapes include: a circle, an oval, a square, a rectangle, and the like.

In some embodiments of the present invention, headrest 100 may facilitate movement of an individual's head relative to their body while the individual's head is being supported by headrest 100. For example, headrest 100 may facilitate movements such as rotation, flexion, extension, and lateral bending, of an individual's neck and shoulders, thereby enabling practitioners to effectively deliver therapies that involve dynamic positioning and active patient engagement.

In one or more embodiments of the present invention:
support arm 14 is slidable along slider rail 12 in increments of less than 2 cm;
ball joint 16 is rotatable in either one of the two degrees of rotation in increments of less than 0.5 degrees;
faceplate 20 is lowerable and raisable along slider rail 12, and may pitch, yaw, and roll about ball joint 16;
one or more of the base, slider rail, support arm, ball joint, and faceplate comprise anodized aluminum;
the thumb screws permit smooth movement of the faceplate along the slider rail, and smooth rotation of the faceplate about the ball joint, thereby allowing precise movements of less than 0.5 degrees; and/or
a cushion is attached to faceplate 20.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “flexion”, “extension”, “swung”, “spun”, “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a ball joint, faceplate, slider rail, support arm, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one, or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method of using an adjustable headrest for performing a manual therapy on an individual, the headrest comprising a base mountable to a treatment table, a slider rail mounted to the base, a support arm configured to slide along the slider rail, a lockable ball joint mounted to the support arm, and a faceplate mounted to the ball joint, the method comprising:
configuring the headrest in a first configuration by sliding the support arm over the slider rail and extending from a first side of the slider rail;
supporting the individual's head with the headrest configured in the first configuration;
performing the manual therapy on the individual with the headrest configured in the first configuration;
detaching the support arm from the slider rail by sliding the support arm off of the slider rail;
configuring the headrest in a second configuration by sliding the support arm over the slider rail and extending from a second side of the slider rail opposing the first side of the slider rail;
supporting the individual's head with the headrest configured in the second configuration; and
performing the manual therapy on the individual with the headrest configured in the second configuration.

2. The method according to claim 1, wherein:
performing the manual therapy on the individual with the headrest configured in the first configuration comprises performing the manual therapy on the individual in a first one of a prone position, a supine position, and a seated position; and
performing the manual therapy on the individual with the headrest configured in the second configuration comprises performing the manual therapy on the individual in a second one of the prone position, the supine position, and the seated position.

3. The method according to claim 1, wherein:
the base comprises a strut having two opposing ends and two mounting members attached to the opposing ends of the strut;
sliding the support arm over the slider rail and extending from the first side of the slider rail comprises sliding the support arm over the slider rail and extending over the two mounting members; and
sliding the support arm over the slider rail and extending from the second side of the slider rail comprises sliding the support arm over the slider rail and opposing the two mounting members.

4. The method according to claim 1, wherein:
configuring the headrest in the first configuration comprises mounting the base to the treatment table with the slider rail extending upward from the base and the treatment table; and
configuring the headrest in the second configuration comprises:
detaching the base from the treatment table; and
mounting the base to the treatment table with the slider rail extending downwards from the base and the treatment table.

5. The method according to claim 4, wherein:
sliding the support arm over the slider rail and extending from the first side of the slider rail comprises sliding the support arm over the slider rail while the slider rail extends upwards from the base; and
sliding the support arm over the slider rail and extending from the second side of the slider rail comprises sliding the support arm over the slider rail while the slider rail extends downwards from the base.

6. The method according to claim 5, wherein:
performing the manual therapy on the individual with the headrest configured in the first configuration comprises performing the manual therapy on the individual in a supine position; and
performing the manual therapy on the individual with the headrest configured in the second configuration comprises performing the manual therapy on the individual in a prone position.

7. The method according to claim 1, wherein:
the base comprises a strut having two opposing ends and two mounting members attached to the opposing ends of the strut;
the method further comprises mounting the base to the treatment table with the slider rail extending upwards from the base and the treatment table;
configuring the headrest in the first configuration comprises sliding the support arm over the slider rail and extending towards the mounting members and over the treatment table; and
configuring the headrest in the second configuration comprises sliding the support arm over the slider rail and extending opposed to the mounting members and opposed to the treatment table.

8. The method according to claim 7, wherein:
performing the manual therapy on the individual with the headrest configured in the first configuration comprises performing the manual therapy on the individual in a supine position; and
performing the manual therapy on the individual with the headrest configured in the second configuration comprises performing the manual therapy on the individual in a seated position.

9. The method according to claim 1, wherein:
the base comprises a strut having two opposing ends and two mounting members attached to the opposing ends of the strut;
configuring the headrest in the first configuration comprises:
mounting the base to the treatment table with the slider rail extending upwards from the base and the treatment table; and
sliding the support arm over the slider rail and extending towards the mounting members and over the treatment table; and
configuring the headrest in the second configuration comprises:
detaching the base from the treatment table;
resting the base and two mounting members upon the treatment table; and
sliding the support arm over the slider rail and extending towards the mounting members.

10. The method according to claim 9, wherein:
performing the manual therapy on the individual with the headrest configured in the first configuration comprises performing the manual therapy on the individual in a supine position; and
performing the manual therapy on the individual with the headrest configured in the second configuration comprises performing the manual therapy on the individual in a seated position.

11. The method according to claim 1, wherein:
the support arm further comprises a thumb screw:
configuring the headrest in the first configuration further comprises locking the thumb screw with the support arm extending from the first side of the slider rail;
detaching the support arm from the slider rail further comprises releasing the thumb screw with the support arm extending from the first side of the slider rail; and
configuring the headrest in the second configuration further comprises locking the thumb screw with the support arm extending from the second side of the slider rail.

12. The method according to claim 3, further comprising mounting the base to the treatment table by sliding the two mounting members into two respective receiving apertures of the treatment table.

13. The method according to claim 1, wherein:
configuring the headrest in the first configuration further comprises locking the lockable ball joint while the support arm extends from the first side of the slider rail;
detaching the support arm from the slider rail further comprises unlocking the lockable ball joint while the support arm extends from the first side of the slider rail; and
configuring the headrest in the second configuration further comprises locking the lockable ball joint while the support arm extends from the second side of the slider rail.

14. The method according to claim 13, wherein locking the lockable ball joint comprises tightening a thumbscrew of the lockable ball joint to restrain movement of the lockable ball joint while performing the manual therapy on the individual.

15. A method of using an adjustable headrest for performing a static manual therapy and a dynamic manual therapy on an individual, the headrest comprising a base mountable to a treatment table, a slider rail mounted to the base, a support arm configured to slide along the slider rail, a lockable ball joint mounted to the support arm, and a faceplate mounted to the ball joint, the method comprising:
supporting the individual's head with the headrest;
applying a first amount of resistance to movement of the ball joint;
performing the static manual therapy on the individual while the ball joint is under the first amount of resistance to movement, wherein the first amount of resistance is sufficient to restrain movement of the faceplate relative to the base while the individual is receiving the static manual therapy;
applying a second amount of resistance to movement of the ball joint less than the first amount of resistance; and
performing the dynamic manual therapy on the individual while moving the faceplate relative to the base and the ball joint is under the second amount of resistance to movement.

16. The method according to claim 15, wherein:
the ball joint comprises a thumb screw;
applying the first amount of resistance to movement of the ball joint comprises tightening the thumb screw by a first number of turns; and
applying the second amount of resistance to movement of the ball joint comprises tightening the thumb screw by a second number of turns less than the first number of turns.

17. The method according to claim 15, wherein moving the faceplate relative to the base comprises one or more of: pitching the ball joint, yawing the ball joint, and rolling the ball joint.

18. The method according to claim 15, wherein moving the faceplate relative to the base comprises one or more of: rotating the ball joint, rolling the ball joint, and spinning the ball joint.

19. The method according to claim 15, wherein performing the static manual therapy on the individual while the ball joint is under the first amount of resistance to movement comprises performing the static manual therapy on one or more of the individual's neck and shoulders, and performing the dynamic manual therapy on the individual while moving the ball joint under the second amount of resistance to movement comprises performing the dynamic manual therapy on one or more of the individual's neck and shoulders while moving the faceplate relative to the base.

20. The method according to claim 19, wherein performing the dynamic manual therapy on one or more of the individual's neck and shoulders while moving the faceplate relative to the base comprises applying pressure to a location on the individual's neck or shoulders, and moving the faceplate relative to the base while holding steady the applied pressure to thereby slide the applied pressure along the individual's neck or shoulders to a second location on the individual's neck or shoulders.
